(19) United States
(12) Patent Application Publication
(10) Pub. No.: US 2019/0177606 A1
(43) Pub. Date: Jun. 13, 2019

(54) METHODS AND MATERIALS FOR GENERATING CONDUCTIVE CHANNELS WITHIN FRACTURE GEOMETRY

(71) Applicant: Saudi Arabian Oil Company, Dhahran (SA)

(72) Inventors: Noor O. Baqader, Khobar (SA); Ahmed M. Gomaa, Khobar (SA); Rajendra Arunkumar Kalgaonkar, Abqaiq (SA)

(21) Appl. No.: 15/836,515

(22) Filed: Dec. 8, 2017

(51) Int. Cl. C09K 8/80; E21B 43/267; C09K 8/68; C09K 8/03; C09K 8/38; C09K 8/70

(52) U.S. Cl. CPC C09K 8/805; E21B 43/267; C09K 8/685; C09K 2208/28; C09K 8/38; C09K 8/703; C09K 8/03

(57) ABSTRACT

Materials and methods for generating isolated pillar structures and conductive channels within hydrofracturing reservoirs are provided herein.

### TECHNICAL FIELD

This invention relates to materials and methods for generating conductive channels within hydrofracturing reservoirs.

### BACKGROUND

Hydraulic fracturing (also referred to as fracking, hydrofracturing, or hydrofracking, for example) is a well stimulation technique in which rock is fractured by high-pressure injection of a liquid. The liquid “fracking fluid” generally consists of water that contains sand or other “proppants” that are suspended with the aid of thickening agents. When the fracking fluid is injected into a wellbore, it can generate cracks in the deep-rock formations through which hydrocarbons such as natural gas and petroleum can flow. When the hydraulic pressure is removed from the well, the small proppant particles (such as sand, resin-coated sand, aluminum oxide, or a ceramic material) can act to hold the fractures open to facilitate the hydrocarbon flow.

### SUMMARY

A conventional proppant pack used in hydrofracturing can lose up to 99% of its conductivity due to gel damage, fines migration, multiphase flow, and non-Darcy flow (see, e.g., Vincent, “Examining our assumptions—have oversimplifications jeopardized our ability to design optimal fracture treatments,” SPE Hydraulic Fracturing Technology Conference, The Woodlands, Tex., Jan. 19-21, 2009; available online at http://dx.doi.org/10.2118/119143-MS) and Gomaa et al., “Computational fluid dynamics applied to investigate development and optimization of highly conductive channels within the fracture geometry,” SPE Hydraulic Fracturing Technology Conference, The Woodlands, Tex., Feb. 9-11, 2016; available online at http://dx.doi.org/10.2118/179143-MS). This document is based, at least in part, on the development of a method for enhancing the conductivity and flow of hydrocarbons from deep-rock formations, through the use of emulsified epoxy resins in the fracking fluid. The emulsified epoxy resin can serve as an improved carrier for the proppant, keeping the fractures open and permitting the flow of hydrocarbons into the wellbore. The pillar fracturing method described herein can generate highly conductive paths for hydrocarbon flow.

In one aspect, this document features a method of fracturing a reservoir. The method can include pumping a pad fluid stage through a wellbore and into the reservoir to generate a fracture geometry; pumping, through the wellbore and into the reservoir, pulses of (a) a first fluid comprising an emulsified solid epoxy resin within or alternately with (b) a second fluid comprising a compatible fracture fluid, wherein the first and second fluid are pumped at a fracture pressure; and pumping a final fluid stage into the reservoir through the wellbore without pulsing.

The pad fluid stage can be a fracturing fluid system containing one or more of an acid stage, a slickwater, a linear gel, a crosslinker gel, a viscoelastic surfactant− (VES−) based gel, and a foam gel.

The pumped pulses of fluid can be injected at a rate per cluster of 1 to 120 barrels per minute (bpm), or at a rate per cluster of 5 to 50 bpm. The method can include pumping alternating pulses of the first fluid and the second fluid, where the pulsing time between the first fluid and the second fluid is from 2 seconds to 10 minutes. In some cases, the pulsing time between the first fluid and the second fluid can be from 10 seconds to 1 minute.

The first fluid can include a mixture of a proppant, a conventional fracture fluid, and the emulsified solid epoxy resin. The emulsified epoxy resin may not have been subjected to surface activation, can be mixed directly with the proppant, and/or can be pumped directly downhole at 300° F. with a water-based fracture fluid. The first fluid can include the emulsified solid epoxy resin, a permeability enhancing agent, and a curing agent. The emulsified solid epoxy resin can be liquid at surface/room temperature and can become a hard plug within two hours or less at 300° F. The first fluid can contain a proppant loading of 0 to 12 pounds per gallon (ppga).

The first fluid can contain a proppant and a permeability enhancing agent. The permeability enhancing agent can dissolve with time, brine, or hydrocarbon flow, pressure, or temperature, to leave a conductive void space within proppant pillars. The permeability enhancing agent can include polylactic acid beads, fibers, or fabrics, or a combination thereof. The permeability enhancing agent can include one or more of a resin, a salt, benzoic acid, an acid salt, or wax beads. The permeability enhancing agent can contain a low vapor pressure liquid or gas (e.g., methanol). The first fluid can include the emulsified epoxy resin and an accelerator that decreases the hardening time of the epoxy resin, or the emulsified epoxy resin and a retarder that prolongs the hardening time of the epoxy resin.

The compressive strength of the first fluid can be greater than an overburden pressure of the reservoir. The first fluid can harden or gel after being pumped into the reservoir, where the compressive strength of the first fluid after it hardens or gels is in the range of 0.00001 psi to 200,000 psi. In some cases, the permeability of the first fluid after it hardens or gels is in the range of 0.01 mD to 20,000 D, or the permeability of the first fluid after it hardens or gels is zero.

The second fluid can be a conventional fracture fluid. The second fluid can be a fracturing fluid system comprising one or more of an acid stage, a slickwater, a linear gel, a crosslinked gel, a VES-based gel, and a foam gel. The second fluid can include a proppant loading of 0 to 12 ppga.

The final fluid stage can contain the first fluid with a proppant loading of 0 to 12 ppga, or the second fluid with a proppant loading of 0 to 12 ppga.

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments of the invention are set forth in the accompanying drawing and the description below. Other features, objects, and advantages of the invention will be apparent from the description and drawing, and from the claims.

### DESCRIPTION OF DRAWING

FIG. 1 is a diagram depicting the geometry of a conventional porous proppant pack (left) and an isolated structure of propped pillars containing a network of open channels (right).

### DETAILED DESCRIPTION

Propping agents, typically referred to as “proppants,” are solid materials—often sand, treated sand, or man-made materials such as ceramics—that are designed to keep an induced hydraulic fracture open during or following a fracturing treatment. A proppant can be added to a fracking fluid, which varies in composition depending on the type of fracturing, and typically are gel-based, foam-based, or slickwater—(water containing one or more chemical additives) based. In general, more viscous fluids can carry more concentrated proppant. Characteristics such as pH and various rheological factors also can affect the concentration of proppant that a fracturing fluid can carry. Other than proppants, slickwater fracturing fluids typically are mostly water (e.g., 99% or more by volume), but gel-based fluids can contain polymers and/or surfactants at as much as 7 vol. %, disregarding other additives. Other additives can include hydrochloric acid (since low pH can etch or dissolve certain types of rock, such as limestone), friction reducers, guar gum, biocides, emulsion breakers, emulsifiers, 2-butoxyethanol, and radioactive tracer isotopes.

The success of a hydraulic fracturing stimulation treatment typically depends on the strength and distribution of the propping agent used to prevent the fracture from closing after the treatment, because the conductivity of the fracture affects well production (see, Van Pooiien, “Productivity vs permeability damage in hydraulically produced fractures,” Paper 906-2-G, presented at Drilling and Production Practice, New York, N.Y., 1 Jan. 1957; Van Pooiien et al., Petr. Trans. AIME 213:91-95, 1958; Kern et al., J. Per. Tech. 13(6):583-589, 1961; Tinsley and Williams, J. Petr. Technol. 27(11): 1319-1325, 1975; and Gomaa et al., supra). Even with simple and wide features and high proppant placement efficiency throughout the entire fracture geometry, mathematical and engineering concepts still often overestimate the flow capacity of fractures by several orders of magnitude (Vincent, “Five things you didn't want to know about hydraulic fractures,” presented at the International Conference for Effective and Sustainable Hydraulic Fracturing, Brisbane, Australia, 20-22 May 2013). The proppant pack generally acts as a porous medium, but permeability can be reduced by residual damage from poor gel recovery, fines migration, multiphase flow, fluid momentum losses (β factor), drag forces, capillary forces, proppant crushing and embedment, or a combination of any of these factors (see, Barree et al., “Realistic assessment of proppant pack conductivity for material selection,” presented at the Annual Technical Conference, Denver, Colo., 5-8 Oct. 2003; Palisch et al., “Determining realistic fracture conductivity and understanding its impact on well performance—theory and field examples,” presented at the Hydraulic Fracturing Technology Conference, College Station, Tex., 29-31 Jan. 2007; Vincent 2009, supra; and Gomaa et al., supra).

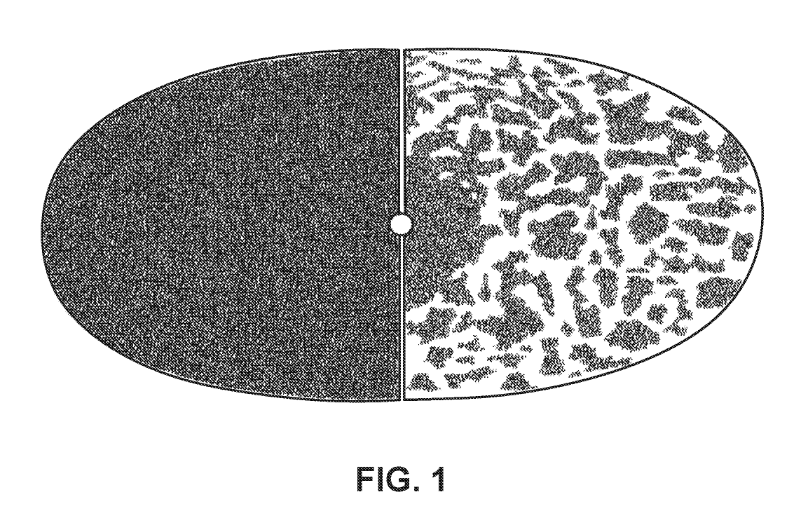

A proppant pillar fracture geometry, also referred to as “channel fracturing,” can be used in place of a standard porous proppant pack. See, e.g., Tinsley and Williams, supra; Walker et al., “Proppants, we still don't need no proppants—a perspective of several operators,” presented at the SPE Annual Technical Conference and Exhibition, New Orleans, La., 27-30 Sep. 1998; Gillard et al., “A New approach to generating fracture conductivity,” presented at the SPE Annual Technical Conference and Exhibition, Florence, Italy, 20-22 Sep. 2010; Gomaa et al., supra; and Gomaa et al., “Improving fracture conductivity by developing and optimizing a channels within the fracture geometry: CFD study,” presented at SPE International Conference on Formation Damage Control, Lafayette, La., 24-26 Feb. 2016). FIG. 1 shows a side by side comparison of a porous proppant pack (left) and an isolated structure of propped pillars containing a network of open channels (right). A pillar fracturing approach can provide greater fracture conductivity than a conventionally propped fracture.

This document provides a new chemistry for generating an isolated structure of propped pillars, with a network of open channels, in a fracture. In general, the chemistry includes mixing an emulsified epoxy resin with a compatible clean fracturing fluid, where the emulsified epoxy resin can carry a proppant during the treatment time as well as during closure time, with almost no settling. The emulsified epoxy resin and fracture fluid can be delivered downhole in pulses, such that the resin can cure and be converted to proppant, resulting in pillar areas that keep the fracture open. The conventional fracture fluid, after it completely breaks, can create open channels as a path flow for hydrocarbons, with almost infinite conductivity.

In some embodiments, this document provides materials and methods for using a water external emulsion of solid epoxy resin for the formation of proppant pillars. The use of a solid epoxy in water emulsion for pillar fracturing is a unique approach that differs from previously used methods in conventional fracturing applications, and even differs from previously used methods involving resin emulsions. Moreover, the water external solid epoxy emulsion can avoid proppant flowback, can be compatible with the aqueous fracturing fluid, and can avoid unwanted sludge formation that can lead to formation damage.

In some embodiments, an emulsion used in the methods provided herein can be comprised of a 1:1 ratio of water to solid epoxy, a 9:1 ratio of water to solid epoxy, or any ratio there between (e.g., 2:1, 3:1, 4:1, 5:1, 6:1, 7:1, or 8:1). Suitable epoxy resins include, without limitation, epoxy resins based on bisphenol A, and epoxy resins based on reaction of epichlorohydrin with on bisphenol F, phenol formaldehyde, aliphatic alcohols, polyols, or aromatic amines. The size of the solid epoxy used in the emulsion can be less than or equal to about 1000 microns (e.g., about 500 to 1000 microns, about 250 to 500 microns, about 100 to 250 microns, or about 50 to 100 microns). The solid epoxy in water emulsion can be used as a carrier fluid for one or more proppants, and can exhibit suspension characteristics that avoid any early screen outs as the pumping regime transitions from a turbulent flow to lamellar flow as the fracture is initiated in subterranean formation.

The melting temperature of the solid epoxy can be greater than or equal to about 60° C. (e.g., about 60 to 65 □, about 65 to 70 □, about 70 to 75 □, about 75 to 80 □, about 80 to 90 □, about 90 to 100 □, about 100 to 150 □, or about 150 to 200 □). As the bottom hole temperature goes to a temperature higher than 60° C., the internal phase of the emulsion (which contains the solid epoxy) can begin to melt, coating the proppant particles and providing sufficient tackiness to make the proppant grains stick together. This feature can avoid potential screen outs after the pillar fracturing operation. In some cases, the fluid containing the emulsified epoxy resin can be liquid at room/surface temperature, but can cure to become a hard plug after a period of time (e.g., about 30 minutes to four hours, within about one hour, within about two hours, or within about three hours) at a suitable temperature (e.g., about 60 to 200 □, or about 100 to 150 □).

The reservoir fracturing methods provided herein can include a first step in which a pad fluid stage is pumped through a wellbore and into a reservoir, thus generating a fracture geometry. Once the initial fracture geometry is generated, pulses of a first fluid and a second fluid can be pumped into the reservoir. For example, a first fluid containing an emulsion of a solid epoxy resin can be pumped into the reservoir in a pulsed fashion, either within or alternately with a second fluid that contains a compatible fracture fluid. After a suitable length of time or number of pulsed injections, a final fluid stage can be pumped into the reservoir, typically without pulsing.

Any suitable pad fluid stage can be used. For example, the pad fluid stage can include a fracturing fluid that contains an acid stage, a slickwater, a linear gel, a crosslinker gel, a viscoelastic surfactant− (VES−) based gel, a foam gel, or a combination of any of these components.

In addition to the emulsified solid epoxy resin, the first fluid may contain a proppant and/or a conventional fracture fluid and/or one or more other components. For example, the first fluid can contain the emulsified epoxy resin, a proppant, and a water-based fracture fluid. In some cases, the emulsified epoxy resin has not been subjected to surface activation, but rather is activated after injection. In some cases, the emulsified resin can be mixed directly with the proppant and then combined with the water-based fracture fluid for injection through the wellbore. When a proppant separate from the emulsified epoxy resin is included in the first fluid, the proppant loading can be from about 0 to 12 pounds per gallon (ppga) (e.g., about 0.1 to 1 ppga, about 0.5 to 2 ppga, about 1 to 3 ppga, about 2 to 4 ppga, about 3 to 5 ppga, about 5 to 8 ppga, about 8 to 10 ppga, or about 10 to 12 ppga). Typically, the compressive strength of the first fluid is greater than an overburden pressure of the reservoir.

In some cases, the first fluid can contain a permeability enhancing agent and or a curing agent in addition to the emulsified solid epoxy resin and, if included, the proppant. The permeability enhancing agent typically will dissolve with time, brine, hydrocarbon flow, pressure, or temperature, to leave a conductive void space within the proppant pillars. Suitable permeability enhancing agents include, without limitation, polylactic acid beads, fibers, fabrics, or any combination thereof; resins, salts, benzoic acid, acid salts, or wax beads; low vapor pressure liquids or gases, and methanol.

The first fluid also may contain an agent that modulates that curing time of the epoxy resin. In some cases, for example, the first fluid can include an accelerator that decreases the hardening time of the epoxy resin. In other cases, the first fluid can include a retardant that prolongs the hardening time of the epoxy resin. Once the first fluid hardens/gels in the reservoir, its compressive strength can be about 0.00001 psi to about 200,000 psi (e.g., about 0.00001 to 0.00005 psi, about 0.00005 to 0.0001 psi, about 0.0001 to 0.001 psi, about 0.001 to 0.01 psi, about 0.01 to 0.1 psi, about 0.1 to 1 psi, about 1 to 10 psi, about 10 to 100 psi, about 100 to 1,000 psi, about 1,000 to 10,000 psi, about 10,000 to 100,000 psi, or about 100,000 to 200,000 psi), and its permeability can be about 0.01 mD to about 20,000 D (e.g., about 0.01 to 0.1 mD, about 0.1 to 1 mD, about 1 to 10 mD, about 10 to 100 mD, about 100 mD to 1 D, about 1 to 10 D, about 10 to 100 D, about 100 to 1,000 D, about 1,000 to 10,000 D, or about 10,000 to 20,000 D). In some cases, the permeability of the first fluid after it hardens/gels can be zero.

The first fluid can be pumped into the reservoir under conditions suitable to cause the epoxy resin to generate pillar structures within the reservoir, either through melting and coating a separate proppant, or through curing such that the resin itself becomes the proppant. In some cases, for example, the first fluid can be injected at a temperature of about 200 □ to about 400° F. (e.g., about 200 to about 250 □, about 250 to about 300 □, about 300 to about 350 □, or about 350 to about 400 □).

The pulses of fluid can be injected at a rate per cluster of 1 to 120 barrels per minute (bpm) (e.g., about 5 to 25 bpm, about 5 to 50 bpm, about 20 to 60 bpm, about 25 to 50 bpm, about 50 to 75 bpm, about 75 to 100 bpm, or about 100 to 120 bpm). When the first and second fluids are separately pulsed when pumped into the reservoir, the pulsing time between the first fluid and the second fluid can be from about 2 seconds to about 10 minutes (e.g., about 2 to 30 seconds, about 30 to 60 seconds, about 10 seconds to 1 minute, about 30 seconds to 2 minutes, about 1 to 3 minutes, about 3 to 5 minutes, about 5 to 7 minutes, or about 7 to 10 minutes).

The second fluid can include a conventional fracture fluid. In some cases, for example, the second fluid can contain one or more of an acid stage, a slickwater, a linear gel, a crosslinked gel, a VES-based gel, and/or a foam gel. The second fluid also can include a proppant, at a loading of about 0 to 12 ppga (e.g., about 0.1 to 1 ppga, about 0.5 to 2 ppga, about 1 to 3 ppga, about 2 to 4 ppga, about 3 to 5 ppga, about 5 to 8 ppga, about 8 to 10 ppga, or about 10 to 12 ppga).

The final fluid stage can include the first fluid or the second fluid. For example, the final fluid stage can include the first fluid, where the fluid includes a proppant (e.g., a proppant with a loading of 0 to 12 ppga). Alternatively, the final fluid stage can include the second fluid, where the fluid includes a proppant (e.g., a proppant at a loading of 0 to 12 ppga).

The invention will be further described in the following example, which does not limit the scope of the invention described in the claims.

### EXAMPLE

### Mixing Proppant Directly with Emulsified Epoxy Resin

A core with width 1.48 inches and height 0.6 inches was prepared by directly pouring emulsified epoxy resin onto 25 grams of a ceramic proppant, such that the proppant was covered by the resin. The mixture was kept at 300° F. for 2 hours, which allowed the resin to cure and formed a hard plug of adherent proppant. The plug was immediately subjected to a mechanical strength test, which showed that the plug could withstand pressure of 5000 psi or higher, even up to 20000 psi. The dimensions of the plug were changed to 7.8 inches wide and less than 0.19 inch high (FIG. 1)—a promising result in terms of handling downhole closure stress.

Twenty (20) PPT (pound per thousand gallon) of a carboxymethyl hydroxypropyl guar (CMHPG) crosslinked gel were mixed with the epoxy resin, 4 PPGA (pound per gallon add) of proppant or sand, and 10 PPT of breaker. The epoxy resin was tested at volume concentrations of 30 vol. % and 50 vol. %. The mixtures were placed inside a pressured cell at 300° F. and 500 psi for 2 hours. The results demonstrated that the epoxy was able to consolidate the proppant to provide a thick proppant pillar (FIG. 2) when mixed with fracturing fluid.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A method of fracturing a reservoir, the method comprising the steps of:
pumping a pad fluid stage through a wellbore and into the reservoir to generate a fracture geometry;
pumping, through the wellbore and into the reservoir, pulses of (a) a first fluid comprising an emulsified solid epoxy resin within or alternately with (b) a second fluid comprising a compatible fracture fluid, wherein the first and second fluid are pumped at a fracture pressure; and
pumping a final fluid stage into the reservoir through the wellbore without pulsing.

2. The method of claim 1, wherein the pad fluid stage is a fracturing fluid system comprising one or more of an acid stage, a slickwater, a linear gel, a crosslinker gel, a viscoelastic surfactant− (VES−) based gel, and a foam gel.

3. The method of claim 1, wherein the pumped pulses of fluid are injected at a rate per cluster of 1 to 120 barrels per minute (bpm).

4. The method of claim 3, wherein the pumped pulses of fluid are injected at a rate per cluster of 5 to 50 bpm.

5. The method of claim 1, comprising pumping alternating pulses of the first fluid and the second fluid, wherein the pulsing time between the first fluid and the second fluid is from 2 seconds to 10 minutes.

6. The method of claim 5, wherein the pulsing time between the first fluid and the second fluid is from 10 seconds to 1 minute.

7. The method of claim 1, wherein the first fluid comprises a mixture of a proppant, a conventional fracture fluid, and the emulsified solid epoxy resin.

8. The method of claim 7, wherein the emulsified epoxy resin is not subjected to surface activation, is mixed directly with the proppant, and is pumped directly downhole at 300° F. with a water-based fracture fluid.

9. The method of claim 8, wherein the emulsified solid epoxy resin is liquid at room temperature and becomes a hard plug within two hours or less at 300° F.

10. The method of claim 1, wherein the first fluid comprises the emulsified solid epoxy resin, a permeability enhancing agent, and a curing agent.

11. The method of claim 10, wherein the emulsified solid epoxy resin is liquid at room temperature and becomes a hard plug within two hours or less at 300° F.

12. The method of claim 1, wherein the first fluid comprises a proppant loading of 0 to 12 pounds per gallon (ppga).

13. The method of claim 1, wherein the first fluid comprises a proppant and a permeability enhancing agent.

14. The method of claim 13, wherein the permeability enhancing agent dissolves with time, brine, or hydrocarbon flow, pressure, or temperature, to leave a conductive void space within proppant pillars.

15. The method of claim 13, wherein the permeability enhancing agent comprises polylactic acid beads, fibers, or fabrics, or a combination thereof.

16. The method of claim 13, wherein the permeability enhancing agent comprises one or more of a resin, a salt, benzoic acid, an acid salt, or wax beads.

17. The method of claim 13, wherein the permeability enhancing agent comprises a low vapor pressure liquid or gas.

18. The method of claim 17, wherein the permeability enhancing agent comprises methanol.

19. The method of claim 1, wherein the first fluid comprises the emulsified epoxy resin and an accelerator that decreases the hardening time of the epoxy resin.

20. The method of claim 1, wherein the first fluid comprises the emulsified epoxy resin and a retarder that prolongs the hardening time of the epoxy resin.

21. The method of claim 1, wherein the compressive strength of the first fluid is greater than an overburden pressure of the reservoir.

22. The method of claim 21, wherein the first fluid hardens or gels after being pumped into the reservoir, and wherein the compressive strength of the first fluid after it hardens or gels is in the range of 0.00001 psi to 200,000 psi.

23. The method of claim 1, wherein the first fluid hardens or gels after being pumped into the reservoir, and wherein the permeability of the first fluid after it hardens or gels is in the range of 0.01 mD to 20,000 D.

24. The method of claim 1, wherein the first fluid hardens or gels after being pumped into the reservoir, and wherein the permeability of the first fluid after it hardens or gels is zero.

25. The method of claim 1, wherein the second fluid is a conventional fracture fluid.

26. The method of claim 1, wherein second fluid is a fracturing fluid system comprising one or more of an acid stage, a slickwater, a linear gel, a crosslinked gel, a VES-based gel, and a foam gel.

27. The method of claim 1, wherein the second fluid comprises a proppant loading of 0 to 12 ppga.

28. The method of claim 1, wherein the final fluid stage comprises the first fluid with a proppant loading of 0 to 12 ppga.

29. The method of claim 1, wherein the final fluid stage comprises the second fluid with a proppant loading of 0 to 12 ppga.
